(19) United States
(12) Patent Application Publication
(10) Pub. No.: US 2003/0132353 A1
(43) Pub. Date: Jul. 17, 2003

(54) Wireless mouse carrier

(75) Inventor: Edward Yeh, Keelung City (TW)

Correspondence Address: BACON & THOMAS, PLLC, 625 SLATERS LANE, FOURTH FLOOR, ALEXANDRIA, VA, 22314

(73) Assignee: Chenming Mold Ind. Corp.

(21) Appl. No.: 10/045,000

(22) Filed: Jan. 15, 2002

(51) Int. Cl. B68G 5/00

(52) U.S. Cl. 248/118

(57) ABSTRACT

A wireless mouse carrier that provides support to a user when a wireless mouse mounted in the wireless mouse carrier is used as a desk mouse on a tabletop. The wireless mouse carrier comprises a recess into which the wireless mouse fits, and a supporting member that surrounds the recess. When the wireless mouse is placed in the recess, the user's hand rests on the supporting member to conveniently operate the wireless mouse on the tabletop.

### FIELD OF THE INVENTION

The invention relates to a carrier for a wireless mouse. More specifically, the present invention relates to a carrier that allows a portable wireless mouse to become a desk mouse for use on a tabletop.

### BACKGROUND OF THE INVENTION

WINDOWS™ is presently the most common operating system used for personal computers. A mouse plays an important role as interface medium between a user and the operating system. With the mouse, computer use is significantly facilitated any instructions and icon/document selection can be conveniently achieved.

To render oral presentations during seminars or conferences more convenient and well illustrated, many professional software applications and related peripheral hardware equipment are commercially available. A wireless mouse is a convenient tool that is necessary for the presentation to be made in the best conditions. With the wireless technology, the presenter can freely perform the presentation and has more interactions with the audience.

Currently, the wireless mouse is designed for portable use and is lightweight and compact. However, the wireless mouse characteristics of lightweight and compactness are appropriate for portable use and not for tabletop use. If the small and hand-held wireless mouse is used on the tabletop, the user has to substantially fold his (her) fingers in order to catch the mouse. Hand fatigue therefore easily occurs.

### SUMMARY OF THE INVENTION

It is therefore a principal object of the invention to provide a wireless mouse carrier that allows a user to conveniently operate the wireless mouse as a desk mouse on a flat surface such as a tabletop.

It is another object of the invention to provide a wireless mouse carrier made of a flexible material that provides the user with a good touch feeling.

To accomplish the above and other objectives, a wireless mouse having a carrier is provided. The carrier principally has a recess into which the wireless mouse fits, and a supporting member surrounding the recess. When the wireless mouse is placed in the recess, a user's hand, while holding the mouse, rests on the supporting member and conveniently operates the mouse on the tabletop by means of the wireless mouse carrier. Provided with the above carrier of the invention, the wireless mouse that is designed for hand-held use immediately becomes a desk mouse adapted for use on the tabletop.

### BRIEF DESCRIPTION OF THE DRAWINGS

The drawings included herein provide a further understanding of the invention and, incorporated herein, constitute a part of the invention disclosure. A brief introduction of the drawings is as follows:

FIG. 1 is a schematic perspective view of a wireless mouse carrier according to an embodiment of the invention;

FIG. 2 is a schematic perspective view of a wireless mouse carrier when carrying a conventional wireless mouse according to an embodiment of the invention; and

FIG. 3 illustrates the wireless mouse mounted into the carrier for desk mouse use.

### DESCRIPTION OF THE PREFERRED EMBODIMENTS

Wherever possible in the following description, similar reference numerals and symbols will refer to similar elements unless otherwise illustrated.

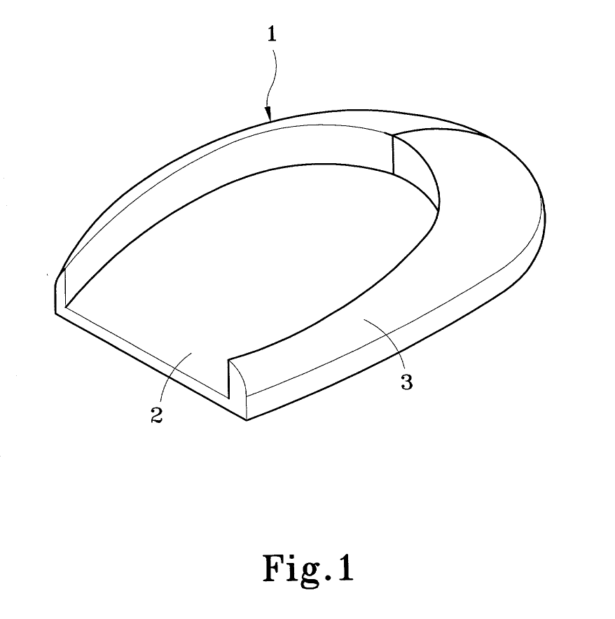

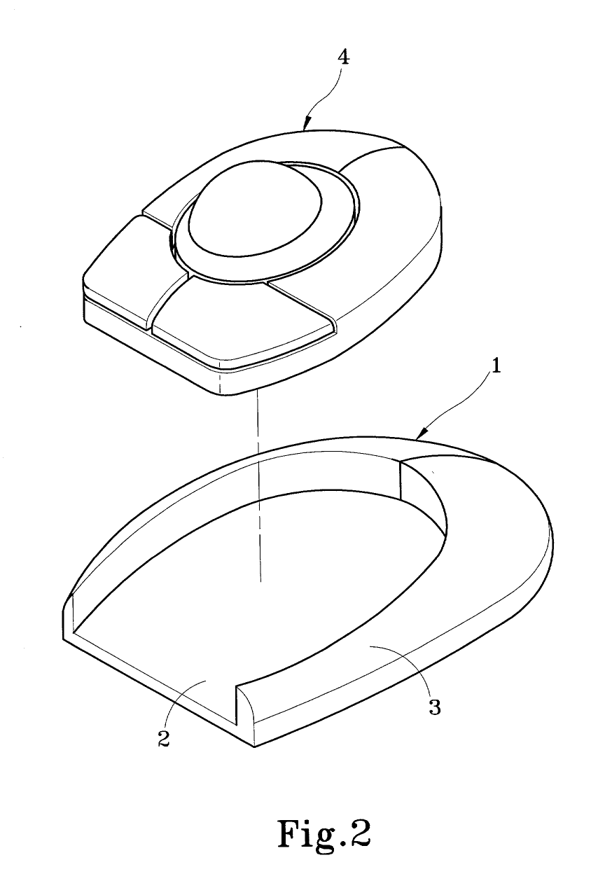

FIG. 1 is a schematic perspective view of a wireless mouse carrier according to an embodiment of the invention. FIG. 2 is a schematic perspective view of a wireless mouse carrier when carrying a conventional wireless mouse according to an embodiment of the invention. A wireless mouse 4 uses radiation frequency (RF) or infrared ray (IR) for signal transmission, which has the advantage of free-obstacle operation. Therefore, it is user-friendly when used in oral presentation for a seminar. A carrier 1 for carrying the wireless mouse 4 provides support to the user's hand, more specifically a wrist, to operate the wireless mouse 4 on a tabletop 5. The carrier 1 principally consists of a recess 2 into which the wireless mouse 4 fits, and a supporting member 3 made of a flexible material that surrounds the recess 2. The recess 2, surrounded by the supporting member 3, has an inner diameter that allows the wireless mouse 4 to be secured therein by closely contacting with the supporting member 3 of the carrier 1 when sliding into the recess 2. Preferably, the inner diameter of the recess 2 is slightly smaller than an outer diameter of the wireless mouse 4. The supporting member 3 provides support to the user's wrist when the wireless mouse 4 is to be manipulated on the tabletop 5. The supporting member 3 has a main portion where the user's wrist is placed, and two side portions. The main portion of the supporting member 3 is wider than the side portions. The main portion and the side portions have smooth surfaces. The flexible material which is used to form the supporting 3 can be, for example, rubber that provides good touch feeling to the user when the user' hand is placed on the supporting 3.

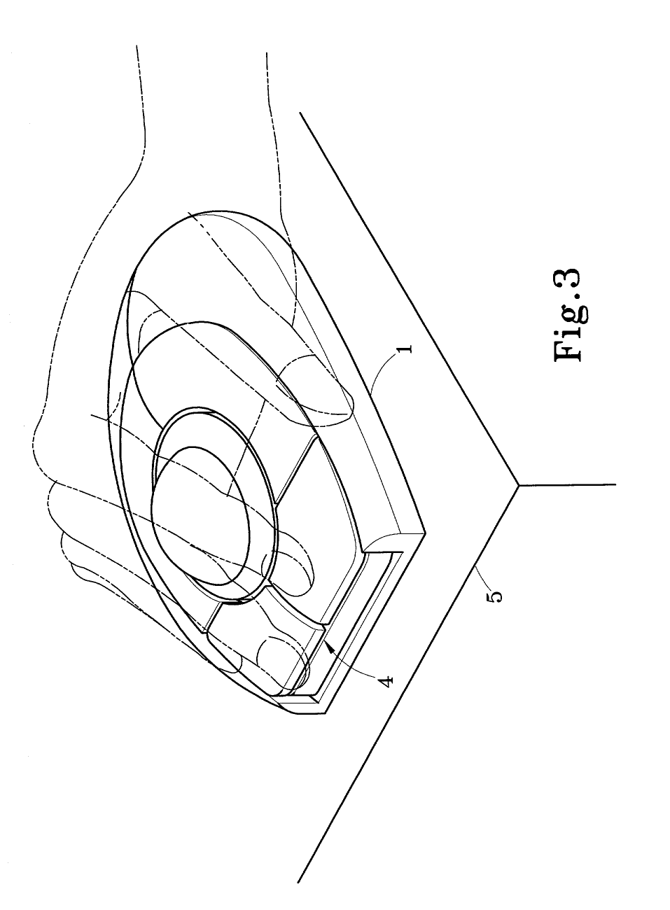

FIG. 3 illustrates the wireless mouse mounted into the carrier in a configuration of manipulation on a tabletop. As shown in FIG. 3, when the wireless mouse 4 is to be used on the table 5, the carrier 4 is first placed on the tabletop 5. The wireless mouse 4 then is put into the recess 2 of the carrier 1. The wireless mouse 4 hence is in close contact with the recess 2 and surrounded by the supporting member 3. The user can rest his (her) wrist on the supporting 3 while using appropriate fingers on the keystrokes of the wireless mouse 4. With the carrier of the invention, the wireless mouse that is designed for hand-held use immediately becomes a desk mouse adapted for use on the tabletop.

In view of the above description, the invention provides the following advantages over the prior art:

1. The carrier 1 for wireless mouse 4 of the invention provides the hand-held wireless mouse 4 with an additional convenient manner of manipulation. Not only the wireless mouse 4 can be portably used during oral presentation, but also it can be operated on a tabletop 4 as a desk mouse.

2. The carrier 1 carrying the wireless mouse 4 provides support to the user's hand when the wireless mouse is used as desk mouse. The user puts his (her) wrist on the supporting member 3 at the periphery of the carrier 1 as he (she) may do on a supporting member of a keyboard. Therefore, the carrier 1 is user-friendly.

3. The supporting member 3 of the carrier 1 is made of rubber that is flexible and, therefore, provides good touch feeling to the user.

It should be apparent to those skilled in the art that the above description is only illustrative of specific embodiments and examples of the invention. The invention should therefore cover various modifications and variations made to the herein-described structure and operations of the invention, provided they fall within the scope of the invention as defined in the following appended claims.

What is claimed is:

1. A wireless mouse carrier that provides support to a user when a wireless mouse is used on tabletop as a desk mouse, comprising:
a recess into which the wireless mouse fits; and
a supporting member surrounding the recess in such manner that with the wireless mouse placed in the recess, the user's hand rests on the supporting member to conveniently operate the wireless mouse as a desk mouse on the tabletop.

2. The carrier of claim 1, wherein the supporting member is made of a flexible material.

3. The carrier of claim 2, wherein the flexible material is rubber.
